(19) United States
(12) Patent Application Publication
(10) Pub. No.: US 2026/0150094 A1
(43) Pub. Date: May 28, 2026

(54) METHOD AND APPARATUS FOR PROVIDING INTEGRATED SENSING AND COMMUNICATION

(71) Applicant: ELECTRONICS AND TELECOMMUNICATIONS RESEARCH INSTITUTE, Daejeon (KR)

(72) Inventors: Soon Gi PARK, Daejeon (KR); Young Jo KO, Daejeon (KR); Keun Young KIM, Daejeon (KR); Yong Sun KIM, Daejeon (KR); Jun Sik KIM, Seoul (KR); Kap Seok CHANG, Daejeon (KR)

(73) Assignee: ELECTRONICS AND TELECOMMUNICATIONS RESEARCH INSTITUTE, Daejeon (KR)

(21) Appl. No.: 19/395,398

(22) Filed: Nov. 20, 2025

(30) Foreign Application Priority Data
Nov. 22, 2024 (KR) 10-2024-0168736
Jul. 9, 2025 (KR) 10-2025-0092051

(51) Int. Cl. H04W 72/044; H04W 24/08

(52) U.S. Cl. CPC H04W 72/046; H04W 24/08

(57) ABSTRACT

A method and apparatus for providing integrated sensing and communication are disclosed. An aspect of the present disclosure provides a method for providing integrated sensing and communication in a wireless communication system, performed by a transmission reception point (TRP), the method comprising: radiating, by the TRP, a sensing transmit beam and a communication transmit beam into different spatial regions, wherein the sensing transmit beam and the communication transmit beam are assigned a same beam ID for a same spatial region.

### CROSS-REFERENCE TO RELATED APPLICATIONS

This application claims priority from Korean Patent Application No. 10-2024-0168736, filed on Nov. 22, 2024, and Korean Patent Application No. 10-2025-0092051, filed on Jul. 9, 2025, the disclosures of which are incorporated by reference herein in their entirety.

### TECHNICAL FIELD

The disclosure relates to a method and an apparatus for providing integrated sensing and communication.

### BACKGROUND

The statements in this section merely provide background information related to the present disclosure and do not necessarily constitute prior art.

Integrated sensing and communication (ISAC) is a core technology in which a new sensing function is fused with an existing communication function within a single system and implemented simultaneously in 5G-advanced and 6G networks.

In ISAC, sensing data may be collected by using a communication network. Sensing may be performed by using existing communication signals, and new sensing signals may be designed to perform sensing based on sensing signals. As a sensing function is provided to a communication system, sensing may be performed by the communications signals themselves, and additionally, sensing performance may be maximized by operating sensing signals simultaneously with the communication signals temporally and spatially.

Meanwhile, in some situations, it may be difficult to simultaneously maximize both communication performance and sensing performance, and therefore an appropriate trade-off may be required through mutual adjustment between the two performances.

### SUMMARY

An object of the present disclosure is to provide a method and an apparatus for providing integrated sensing and communication (ISAC). Regardless of whether active sensing or passive sensing is employed, a receive unit may extract sensing echo signals from temporal and spatial perspectives and may derive sensing information by performing a data process and a processing for the sensing echo signals. At this time, interference at the receive unit affects sensing performance; therefore, processing of interference is important. As interference processing methods, there may be a proactive measure to prevent interference from occurring in advance, and reactive processing methods to remove interference that has already occurred may also be considered.

The disclosure proposes a proactive processing method for removing interference at the receive unit in advance for interference processing. Specifically, the main purpose is to provide a method and an apparatus for providing integrated sensing and communication that mitigate mutual interference between communication functions and sensing functions by operating a dual beam to radiate a sensing beam and a communication beam into different spatial regions and sharing radiation information among respective transmission reception points (TRPs) within a beam cluster.

The technical objects of the present disclosure are not limited to those described above, and other technical objects not mentioned above may be understood clearly by those skilled in the art from the descriptions given below.

An embodiment of the present disclosure provides a method for providing integrated sensing and communication in a wireless communication system, performed by a transmission reception point (TRP), the method comprising: radiating, by the TRP, a sensing transmit beam and a communication transmit beam into different spatial regions, wherein the sensing transmit beam and the communication transmit beam are assigned a same beam ID for a same spatial region.

Another embodiment of the present disclosure provides a method for providing integrated sensing and communication in a wireless communication system, performed by a beam cluster comprising one or more TRPs, the method comprising: sharing, by each TRP within the beam cluster, operation information for all TRPs within the beam cluster; setting, based on the operation information, a start time point and an end time point for each TRP within the beam cluster such that the each TRP operates as a transmitting TRP and all TRPs other than the each TRP operate as receiving TRPs; setting a transmitting TRP and receiving TRPs based on the set start time point and end time point; radiating, by the set transmitting TRP, the sensing transmit beam and the communication transmit beam into different spatial regions; and storing, by the set receiving TRPs, measurement information for the sensing transmit beam and the communication transmit beam, wherein the setting of the transmitting TRP and the receiving TRPs, the radiating, and the storing of the measurement information are repeatedly performed by sequentially setting each TRP within the beam cluster as the transmitting TRP, and wherein the sensing transmit beam and the communication transmit beam are assigned a same beam ID for a same spatial region.

Another embodiment of the present disclosure provides an apparatus for performing integrated sensing and communication in a wireless communication system, the apparatus including a TRP, wherein the apparatus comprising: at least one memory storing instructions; and at least one processor configured to execute the instructions to perform operations comprising: radiating, by the TRP, a sensing transmit beam and a communication transmit beam into different spatial regions, wherein the sensing transmit beam and the communication transmit beam are assigned a same beam ID for a same spatial region.

Another embodiment of the present disclosure provides an apparatus for performing integrated sensing and communication in a wireless communication system, the apparatus being configured to operate a beam cluster comprising one or more TRPs, and the apparatus comprising: at least one memory storing instructions; and at least one processor configured to execute the instructions to perform operations comprising: sharing, by each TRP within the beam cluster, operation information for all TRPs within the beam cluster; setting, based on the operation information, a start time point and an end time point for each TRP within the beam cluster such that the each TRP operates as a transmitting TRP and all TRPs other than the each TRP operate as receiving TRPs; setting a transmitting TRP and receiving TRPs based on the set start time point and end time point; radiating, by the set transmitting TRP, the sensing transmit beam and the communication transmit beam into different spatial regions; and storing, by the set receiving TRPs, measurement information for the sensing transmit beam and the communication transmit beam, wherein the setting of the transmitting TRP and the receiving TRPs, the radiating, and the storing of the measurement information are repeatedly performed by sequentially setting each TRP within the beam cluster as the transmitting TRP, and wherein the sensing transmit beam and the communication transmit beam are assigned a same beam ID for a same spatial region.

According to an embodiment of the present disclosure, performance degradation in an integrated sensing and communication environment may be mitigated by using a dual beam operation structure that simultaneously radiates a communication beam and a sensing beam into different spatial regions.

According to an embodiment of the present disclosure, sensing may be performed by using a coarse beam, thereby improving detection speed in an object detection stage.

According to an embodiment of the present disclosure, sensing may be performed by using a fine beam, thereby enabling precise estimation of an object's position.

According to an embodiment of the present disclosure, in a monostatic sensing scheme, self-interference induced from a transmit antenna may be prevented by using a single transmission reception point (TRP) in which a transmit antenna and a receive antenna are separated.

According to an embodiment of the present disclosure, in monostatic sensing scheme, bistatic sensing scheme, or multistatic sensing scheme, degradation of sensing performance and communications performance due to interference between TRPs may be prevented by sharing radiation information among a plurality of TRPs included in a beam cluster.

The technical effects of the present disclosure are not limited to the technical effects described above, and other technical effects not mentioned herein may be understood to those skilled in the art to which the present disclosure belongs from the description below.

### BRIEF DESCRIPTION OF THE DRAWINGS

FIG. 1 is a schematic diagram showing a monostatic sensing scheme of a wireless communication device according to an embodiment of the disclosure.

FIG. 2 is a schematic diagram showing a bistatic sensing scheme of a wireless communication device according to an embodiment of the disclosure.

FIG. 3 is a flowchart showing an integrated sensing and communication process in a monostatic sensing scheme or a bistatic sensing scheme according to an embodiment of the disclosure.

FIG. 4A is a diagram exemplarily showing integrated sensing and communication that radiates a coarse beam in a monostatic sensing scheme according to an embodiment of the disclosure.

FIG. 4B is a diagram showing an example in which power of a coarse transmit beam and power of a coarse receive beam are distributed over a spatial domain according to an embodiment of the disclosure.

FIG. 4C is a diagram showing an example in which power of a coarse transmit beam and power of a coarse receive beam are distributed over a time domain according to an embodiment of the disclosure.

FIG. 5A is a diagram exemplarily showing integrated sensing and communication that radiates a fine beam in a monostatic sensing scheme according to an embodiment of the disclosure.

FIG. 5B is a diagram showing an example in which power of a fine transmit beam and power of a fine receive beam are distributed over a spatial domain according to an embodiment of the disclosure.

FIG. 5C is a diagram showing an example in which power of a fine transmit beam and power of a fine receive beam are distributed over a time domain according to an embodiment of the disclosure.

FIG. 6 is a graph showing a distribution of power of a receive beam according to an angle of a receive antenna according to an embodiment of the disclosure.

FIG. 7 is a flowchart for explaining a pre-calibration for integrated sensing and communication in a monostatic sensing scheme or bistatic sensing scheme according to an embodiment of the disclosure.

FIG. 8 is a schematic diagram showing a sensing process using coarse beams of a beam cluster formed by a plurality of TRPs according to an embodiment of the disclosure.

FIG. 9 is a schematic diagram showing a sensing process using fine beams of a beam cluster formed by a plurality of TRPs according to an embodiment of the disclosure.

FIG. 10 is a block diagram illustrating an exemplary computing device that may be used for implementing a method or an apparatus according to the present disclosure.

### DETAILED DESCRIPTION

Hereinafter, some exemplary embodiments of the present disclosure will be described in detail with reference to the accompanying drawings. In the following description, like reference numerals preferably designate like elements, although the elements are shown in different drawings. Further, in the following description of some embodiments, a detailed description of known functions and configurations incorporated therein will be omitted for the purpose of clarity and for brevity.

Additionally, various terms such as first, second, A, B, (a), (b), etc., are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

The following detailed description, together with the accompanying drawings, is intended to describe exemplary embodiments of the present invention, and is not intended to represent the only embodiments in which the present invention may be practiced.

According to an embodiment of the disclosure, a method and an apparatus for providing integrated sensing and communication (ISAC) may be used in a wireless communication system. Here, the wireless communication system may be used interchangeably with a wireless communications network. The wireless communication system may be defined in accordance with 3rd generation partnership project (3GPP) standards. For example, it may include a 4th generation (LTE; Long Term Evolution) system, a 5th generation (NR; New Radio) system, a next-generation communication system such as a 6G communication system, or a new form of communication system, and is not limited to any particular generation or form. The wireless communication system may be configured to include a radio access network (RAN) and a core network (CN). The wireless communication system may include a base station or user equipment (UE).

In the specification, the base station may be used as a concept including an evolved Node Base station (eNB) of an LTE system as defined in 3GPP standards, a next generation Node Base station (gNB) of a 5G NR system, or a base station of a next-generation communication system.

In the specification, the user equipment (UE) means a user device that accesses the wireless communication system to perform data transmission and reception. The user equipment according to an embodiment of the disclosure may include a mobile phone, a tablet computer, a laptop computer, an ultra-mobile personal computer (UMPC), a network computer, a personal digital assistant (PDA), or the like.

The integrated sensing and communication (ISAC) means a technology of integrally performing a sensing function and a communication function by using the same wireless system and wireless resources. A wireless communication system according to an embodiment of the disclosure is configured to include a structure to which integrated sensing and communication (ISAC) technology may be applied. The wireless communication system according to an embodiment of the disclosure may support beamforming technology to improve communications quality and enhance spatial resolution. In addition, a beam sweeping procedure may be performed during an initial access procedure or directional search for a target object. Beamforming means a technology that uses a plurality of antennas to concentrate the power gain of a radio signal in a specific direction or to improve the receiver sensitivity of a signal in a specific direction. Beam sweeping means a technology of searching for an optimal beam direction by sequentially transmitting or receiving a signal for a plurality of predefined beam directions.

A multistatic sensing scheme means a sensing scheme that uses two or more TRPs that are physically spaced apart. The multistatic sensing scheme may be configured by combining a plurality of bistatic sensing structures, or may be operated by combining monostatic sensing and bistatic sensing.

In the specification, a beam cluster means a logical group in which a plurality of TRPs or a plurality of beams are operated as a single control unit. Some or all of a plurality of TRPs within the beam cluster, may be set as transmitting TRPs, and some or all may be set as receiving TRPs.

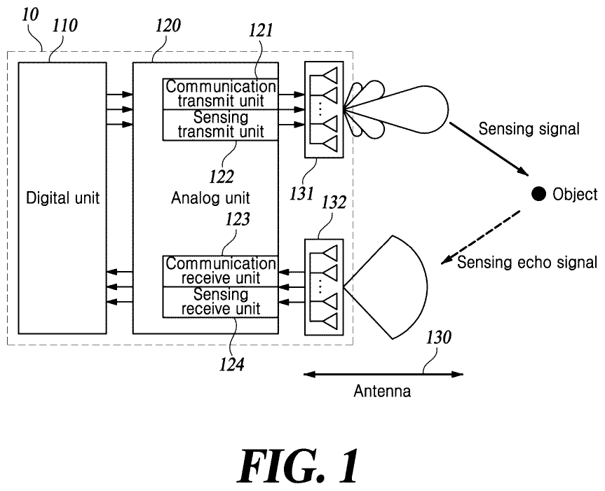

FIG. 1 is a schematic diagram showing a monostatic sensing scheme of a wireless communication device according to an embodiment of the disclosure.

The wireless communication device 10 according to the embodiment of the disclosure means a device that transmits or receives a radio signal in a wireless communication system, and the wireless communication device 10 may be a user equipment or a base station. The wireless communication device 10 may be implemented as a fixed type or a mobile type and may perform one or more of a transmit function and a receive function.

Referring to FIG. 1, the wireless communication device 10 according to an embodiment of the disclosure may be configured to include a digital unit 110, an analog unit 120, and an antenna 130. The digital unit 110 performs baseband signal processing for a wireless communication and a sensing function and controls generation and conversion of transmit/receive signals in connection with the analog unit 120. The analog unit 120 may include a plurality of transmit/receive units, and specifically, may include a communication transmit unit 121, a sensing transmit unit 122, a communication receive unit 123, and a sensing receive unit 124. The antenna 130 may include a transmit antenna 131 and a receive antenna 132, and may perform the transmission and reception of the communication signals and the sensing signals. The transmit antenna 131 and the receive antenna 132 may be disposed physically separated from each other.

The digital unit 110 may deliver communication data to the communication transmit unit 121. The communication transmit unit 121 may modulate the delivered communication data into a communication signal in an analog form. The communication transmit unit 121 may transmit the modulated communication signal by radiating, by using the transmit antenna 131, a communication transmit beam to which beamforming and/or beam sweeping is applied. The receive antenna 132 may receive the communication signal from an external wireless communication device by forming a communication receive beam to which beamforming and/or beam sweeping is applied. The communication receive unit 123 may convert and demodulate the received communication signal and deliver the result to the digital unit 110.

Referring to FIG. 1, the wireless communication device 10 according to an embodiment of the disclosure may operate a monostatic sensing scheme. The monostatic sensing scheme means a sensing scheme that uses a single transmit/receive device or uses a transmit antenna and a receive antenna that are disposed in a physically within the same device. The digital unit 110 may generate a digital signal waveform for generating a sensing signal and deliver the digital signal waveform to the sensing transmit unit 122. The sensing transmit unit 122 may generate the sensing signal in analog form based on the delivered digital signal waveform. The sensing transmit unit 122 may radiate, by using the transmit antenna 131, a sensing transmit beam to which beamforming and/or beam sweeping is applied, thereby radiating the generated sensing signal toward an object. The sensing transmit unit 122 may radiate the sensing signal in different azimuth directions depending on the time point by using the transmit antenna 131. The radiated sensing signal reaches the object and is reflected, and the signal reflected by the object is defined as a sensing echo signal. The sensing echo signal reflected by the object may have different intensity depending on a transmit azimuth of the transmit antenna 131. The wireless communication device 10 may form, by using the receive antenna 132, a sensing receive beam that is directed toward one or more receive azimuths through beamforming and/or beam sweeping, and receive the sensing echo signal that is reflected and arrives in the receive-azimuth direction. In this case, the received sensing echo signal may also be referred to as a back scattering signal. The wireless communication device 10 may form sensing receive beam sequentially or parallelly in correspondence with the receive azimuth or an angular range obtained by subdividing the receive azimuth, and by using the respective receive beam, receive the sensing echo signal arriving in respective receive-azimuth directions in a distinguished manner. The sensing receive unit 124 may convert the received sensing echo signal into a digital signal and deliver it to the digital unit 110.

In the specification, a transmission reception point (TRP) means a point or component that performs transmission and reception of radio signals, and may be implemented as a physical sub-unit or a logical sub-unit of a wireless communication device. For example, a plurality of TRPs may exist within a single base station, and each TRP may independently perform operations such as beamforming, transmission scheduling, and reception processing. The transmission reception point (TRP) according to an embodiment of the disclosure may be referred to as including the analog unit 120 and/or the antenna 130. In the monostatic sensing scheme, a single TRP may perform a transmit function and a receive function. The TRP may commonly operate the communication function and the sensing function by configuring a single radio frequency (RF) chain, or may operate the respective functions independently by respectively configuring a communication RF chain and a sensing RF chain. Accordingly, the sensing transmit beam and the communication transmit beam may be generated by the single RF chain or may be respectively generated by different RF chains. Likewise, the sensing receive beam and the communication receive beam may be processed by the single RF chain or may be respectively processed by different RF chains.

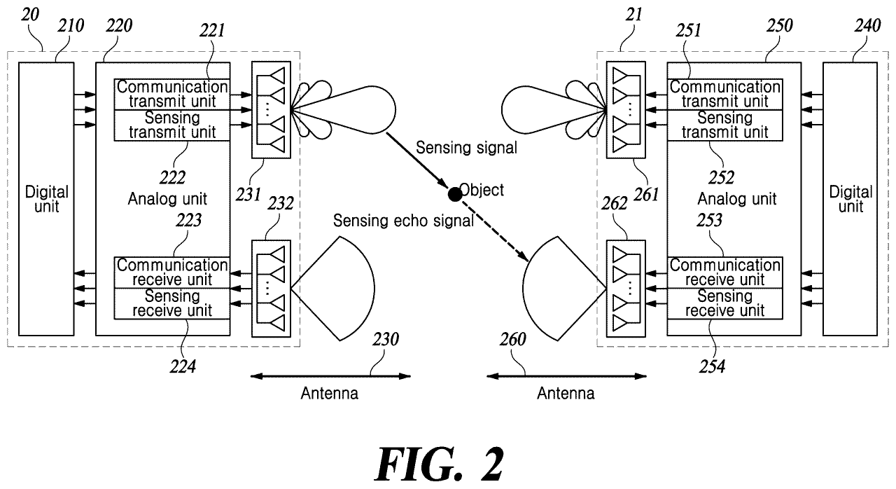

FIG. 2 is a schematic diagram showing a bistatic sensing scheme of a wireless communication device according to an embodiment of the disclosure.

Referring to FIG. 2, a first wireless communication device 20 and a second wireless communication device 21 according to an embodiment of the disclosure may operate a bistatic sensing scheme. The bistatic sensing scheme means a sensing scheme that uses two TRPs that are physically spaced apart. In the bistatic sensing scheme, a transmitting TRP radiates the sensing signal and a receiving TRP receives the sensing echo signal. The first wireless communication device 20 and the second wireless communication device 21 may each be any one of a base station or user equipment. For example, the first wireless communication device 20 and the second wireless communication device 21 may be configured as any combination of base station-base station, base station-user equipment, user equipment-base station, or user equipment-user equipment. According to an embodiment of the disclosure, the first wireless communication device 20 may be a device including the transmitting TRP, and the second wireless communication device 21 may be a device including the receiving TRP.

Referring to FIG. 2, the first wireless communication device 20 according to an embodiment of the disclosure may be configured to include a digital unit 210, an analog unit 220, and an antenna 230. The analog unit 220 may include a communication transmit unit 221, a sensing transmit unit 222, a communication receive unit 223, and a sensing receive unit 224. The antenna 230 may include a transmit antenna 231 and a receive antenna 232. The transmit antenna 231 and the receive antenna 232 may be disposed physically separated from each other. The second wireless communication device 21 according to an embodiment of the disclosure may be configured to include a digital unit 240, an analog unit 250, and an antenna 260. The analog unit 250 may include a communication transmit unit 251, a sensing transmit unit 252, a communication receive unit 253, and a sensing receive unit 254. The antenna 260 may include a transmit antenna 261 and a receive antenna 262. The transmit antenna 261 and the receive antenna 262 may be disposed physically separated from each other.

The digital unit 210 of the first wireless communication device 20 may deliver communication data to the communication transmit unit 221. The communication transmit unit 221 may modulate the delivered communication data into a communication signal in an analog form. The communication transmit unit 221 may transmit the modulated communication signal by radiating, by using the transmit antenna 231, a communication transmit beam to which beamforming and/or beam sweeping is applied. The second wireless communication device 21 may receive a communication signal from the first wireless communication device 20 by forming, by using the receive antenna 262, a communication receive beam to which beamforming and/or beam sweeping is applied. The communication receive unit 253 of the second wireless communication device 21 may convert and demodulate the received communication signal and deliver the result to the digital unit 240. Meanwhile, although a case has been exemplified in which the first wireless communication device 20 performs communication transmission and the second wireless communication device 21 performs communication reception, the disclosure is not limited thereto. For example, the first wireless communication device 20 may perform communication transmission and a third wireless communication device may perform communication reception, and the third wireless communication device may perform communication transmission and the second wireless communication device 21 may perform communication reception.

The digital unit 210 of the first wireless communication device 20 may generate a digital signal waveform to generate the sensing signal, and deliver the digital signal waveform to the sensing transmit unit 222. The sensing transmit unit 222 may generate the sensing signal in analog form based on the delivered digital signal waveform. The sensing transmit unit 222 may radiate, by using the transmit antenna 231, a sensing transmit beam to which beamforming and/or beam sweeping is applied, thereby radiating the generated sensing signal toward an object. The sensing transmit unit 222 may radiate the sensing signal in different azimuth directions depending on the time point using the transmit antenna 231. The radiated sensing signal reaches the object and is reflected, and the signal reflected by the object is defined as a sensing echo signal. The sensing echo signal reflected by the object may have different intensity depending on a transmit azimuth of the transmit antenna 231. The second wireless communication device 21 may form, by using the receive antenna 262, a sensing receive beam that is directed toward one or more receive azimuths through beamforming and/or beam sweeping, and receive the sensing echo signal that is reflected and arrives in the receive-azimuth direction. In this case, the received sensing echo signal may also be referred to as a forward scattering signal. The second wireless communication device 21 may form sensing receive beam sequentially or parallelly in correspondence with the receive azimuth or an angular range obtained by subdividing the receive azimuth, and by using the respective receive beam, receive the sensing echo signal arriving in respective receive-azimuth directions in a distinguished manner. The sensing receive unit 254 of the second wireless communication device 21 may convert the received sensing echo signal into a digital signal and deliver it to the digital unit 240.

According to an embodiment of the disclosure, a first TRP may be referred to as including the analog unit 220 and/or the antenna 230 of the first wireless communication device 20. A second TRP may be referred to as including the analog unit 250 and/or the antenna 260 of the second wireless communication device 21. The first TRP and the second TRP may commonly operate the communication function and the sensing function by configuring a single RF chain, or may operate the respective functions independently by respectively configuring a communication RF chain and a sensing RF chain. Accordingly, the sensing transmit beam and the communication transmit beam may be generated by the single RF chain of the first TRP, or may be respectively generated by different RF chains of the first TRP. Likewise, the sensing receive beam and the communication receive beam may be processed by the single RF chain of the second TRP, or may be respectively processed by different RF chains of the second TRP.

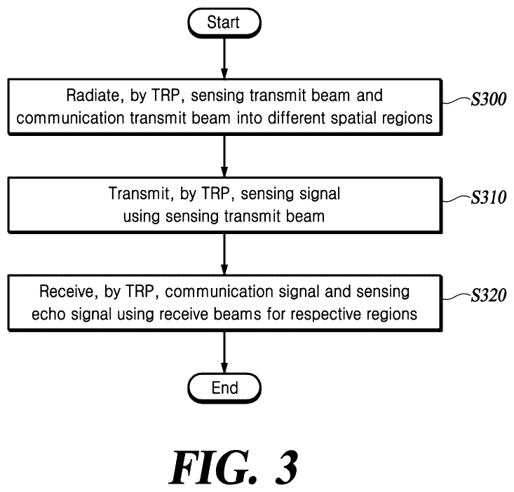

FIG. 3 is a flowchart showing an integrated sensing and communication process in a monostatic sensing scheme or a bistatic sensing scheme according to an embodiment of the disclosure.

Referring to FIG. 1, in a monostatic sensing scheme, a single transmit/receive-integrated TRP may be operated in the single system, or a transmitting TRP and a receiving TRP may be operated in a separated manner. Accordingly, within the single system, a sensing transmit function may be performed, and a sensing receive function corresponding to the sensing transmission may also be performed.

Referring to FIG. 2, in a bistatic sensing scheme, a TRP in a first system may perform the sensing transmit function, and a TRP in a second system may perform the sensing receive function corresponding to the sensing transmission of the first system.

According to an embodiment of the disclosure, the TRP radiates the sensing transmit beam and the communication transmit beam into different spatial regions (S300). The spatial region means a physical region partitioned according to radiation angle or radiation direction, which is a target section in which the TRP radiates or forms beams. The TRP may form and operate the sensing transmit beam and the communication transmit beam using beamforming technology. The sensing transmit beam and the communication transmit beam may be generated by a single RF chain, or may be respectively generated by different RF chains.

Additionally, according to an embodiment of the disclosure, the sensing transmit beam and the communication transmit beam may be assigned a same beam ID for a same spatial region. For example, at a first time point, the sensing transmit beam may be radiated to region a, and the communication transmit beam may be radiated to region b. At a second time point, the sensing transmit beam may be radiated to region b, and the communication transmit beam may be radiated to region c. In such a manner that a spatial beam ID of the communication transmit beam radiated to region b at the first time point and a spatial beam ID of the sensing transmit beam radiated to region b at the second time point are set to be same, beams radiated to the same region may use the same beam ID.

A beam ID means an orthogonal code, and different orthogonal codes may be generated respectively for the sensing transmit beam and the communication transmit beam for the same region. Alternatively, when designing the orthogonal code, a front portion of the code may use a same value for the sensing transmit beam and the communication transmit beam corresponding to the same region, and a rear portion of the code may be designed differently so that the sensing transmit beam and the communication transmit beam are distinguishable even when they correspond to the same region. A receive unit that receives the echo signal may decode the orthogonal code to identify which region the beam generated the echo signal was radiated to, and may further distinguish whether the echo signal was generated by the sensing beam or by the communication beam.

Such spatial beam IDs may be preset corresponding to configured spatial regions. The TRP may map beam IDs to each transmit beam based on the radiation direction of each transmit beam. The TRP may establish a beam ID table to maintain consistency of beam IDs across time points. The beam IDs are not duplicated spatially and are coded to have mutual orthogonality. The sensing transmit beam may be sequentially radiated to different spatial regions over time according to beam sweeping.

The TRP transmits a sensing signal radiated by the TRP using a sensing transmit beam (S310). The TRP may transmit the sensing signal into different spatial regions in each time section by changing the radiation angle or radiation direction of the sensing transmit beam over time using beam sweeping. When an object is present within a spatial region to which the sensing transmit beam is radiated, the sensing signal may be reflected by the object. The signal reflected by the object is defined as a sensing echo signal.

The TRP receives a communication signal and a sensing echo signal using receive beams for each region (S320). For sensing reception, the TRP may simultaneously form the receive beams corresponding to respective regions using beamforming technology and may measure signals using the formed receive beams. Measurement of the receive beams for respective regions may be performed by sequentially or simultaneously receiving signals in respective directions, considering the directions of beams that are directed toward different spatial regions. The TRP may sense the spatial region in which an object is located by analyzing the sensing echo signals received from the respective directions.

Additionally, when the beam ID (e.g., orthogonal code) for the received sensing echo signal is decoded, a range to the object may be estimated by using a time difference between the transmit beam and the receive beam together with the spatial region in which the object is present. Further, when the sensing echo signal is received by using two or more spatially separated antenna elements or antenna assemblies, not only the range to the object but also spatial coordinates (x, y, z) of the object may be calculated. For example, when power of a sensing echo signal received within a specific spatial region is equal to or greater than a set reference value (e.g., a noise level), the received signal may be determined to be a sensing echo signal caused by the object, and a distance to the object may be estimated based on the time difference between the transmit beam and the receive beam. In addition, by using two or more spatially separated antenna elements or antenna assemblies, not only the distance but also three-dimensional coordinates of the object may be derived. Calculation of the three-dimensional coordinates of the object may be performed based on a geometric calculation.

Meanwhile, a radar cross section (RCS) information or a range-doppler map may be generated through signal conversion of the sensing echo signal, and based on this, artificial intelligence (AI) may be used to classify object types (e.g., vehicles, people, birds, drones, etc.). Furthermore, when training data in an amount equal to or greater than a predefined criterion is secured, a detailed classification within a same object group (e.g., product-specific classification for drone objects, etc.) may also be performed. However, the disclosure focuses on range and position coordinate calculation based on the sensing echo signal, and a specific implementation of artificial intelligence-based object classification technology is not described in detail in the specification.

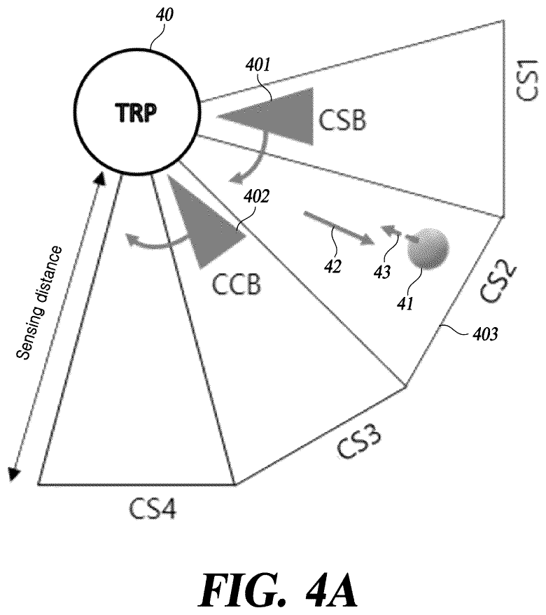

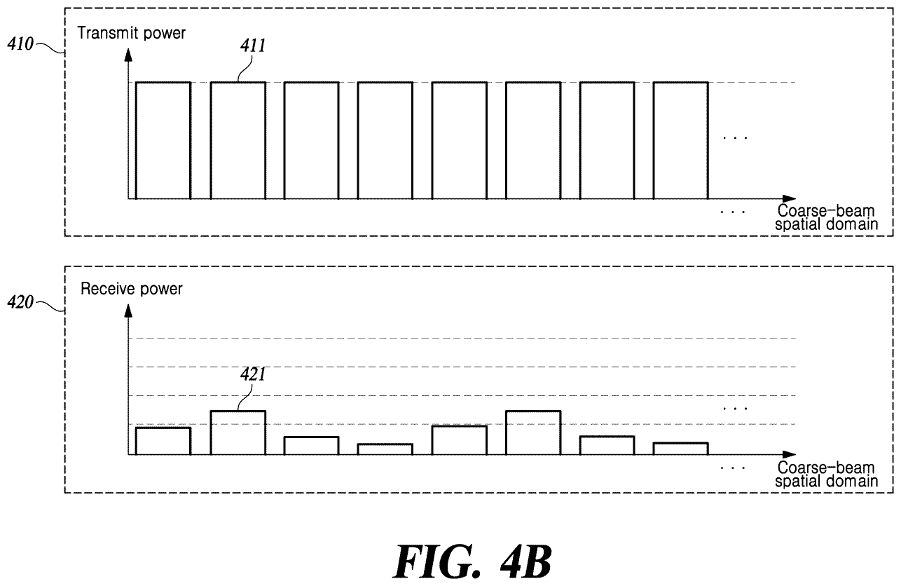

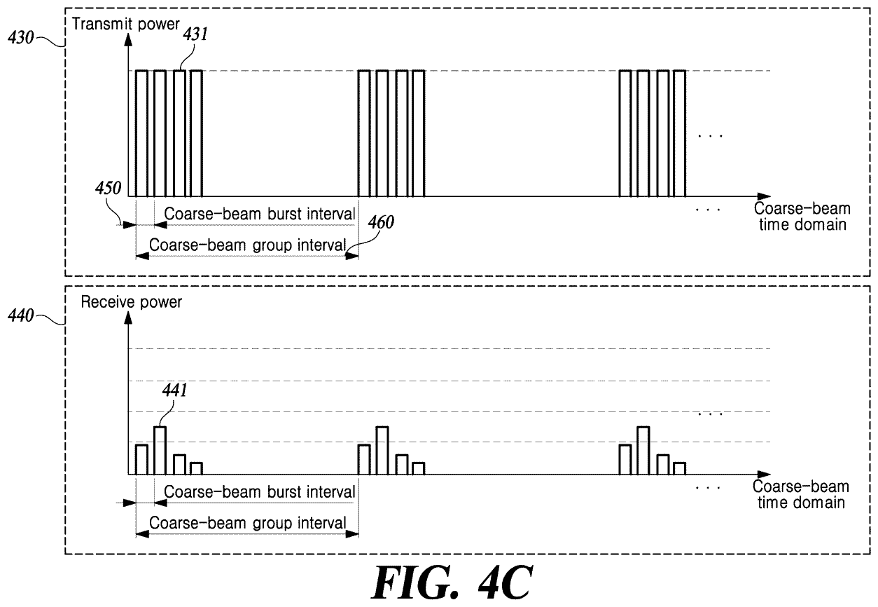

FIG. 4A is a diagram exemplarily showing integrated sensing and communication that radiates a coarse beam in a monostatic sensing scheme according to an embodiment of the disclosure.

In the specification, a coarse beam means a transmit/receive beam formed to have a relatively wide beam coverage, and has a relatively low angular resolution. A fine beam means a transmit/receive beam formed to have a relatively narrow beam coverage, and has a relatively high angular resolution. The coarse beam may be used for an initial search for an object, and the fine beam may be used to identify a precise position of the object. For example, after detecting a target in a relatively wide angular range using the coarse beam, beam alignment and sensing may be performed in a relatively narrow angular range using the fine beam.

Referring to FIG. 4A, a TRP 40 radiates a coarse sensing beam (CSB) 401 and a coarse communication beam (CCB) 402 across a coarse space (CS). The coarse space (CS) means a spatial region partitioned based on the radiation direction of coarse beam of the TRP. The coarse space (CS) according to an embodiment of the disclosure may be partitioned into CS1, CS2 403, CS3, and CS4. The TRP 40 may radiate the sensing beam or the communication beam for each coarse space. At the same time point, the TRP 40 radiates the sensing beam and the communication beam into different spatial regions.

Referring to FIG. 4A, the TRP 40 may radiate (or form, hereinafter referred to as ‘radiate’) a coarse sensing beam 401 to CS1 and a coarse communication beam 402 to CS3 at the first time point. Thereafter, as the TRP 40 performs beam sweeping, the TRP may radiate the coarse sensing beam 401 to CS2 (403) and the coarse communication beam 402 to CS4 at the second time point. An object 41 is located within a sensing distance of the TRP 40, and is present in a spatial region corresponding to CS2 403. The TRP 40 may transmit a sensing signal 42 to CS2 403 using the coarse sensing beam 401 at the second time point. The transmitted sensing signal 42 reaches the object 41 and is then reflected, and the signal reflected by the object 41 is defined as a sensing echo signal 43. The TRP 40 may determine that the object 41 is present in CS2 403 by receiving and signal-processing the sensing echo signal 43.

In the coarse space (CS) according to an embodiment of the disclosure, different beam IDs (e.g., different orthogonal codes) may be pre-assigned for respective spatial regions. Since the TRP 40 radiates the coarse sensing beam 401 and the coarse communication beam 402 into different spatial regions at the same time point, the beam IDs of the coarse sensing beam 401 and the coarse communication beam 402 at the same time point are different. Meanwhile, the coarse sensing beam 401 and the coarse communication beam 402 radiated to the same spatial region at different time points may share the same beam ID. For example, the beam ID of the coarse communication beam 402 radiated to CS3 at the first time point and the beam ID of the coarse sensing beam 401 radiated to CS3 at a third time point may be same. In addition, even when they correspond to the same spatial region, different beam IDs may be assigned to the communication transmit beam and the sensing transmit beam, respectively. For example, independent beam IDs may be set for each region for the communication transmit beam and the sensing transmit beam, respectively, and the beam ID of the communication transmit beam and the beam ID of the sensing transmit beam may be configured to be selected from different beam ID pools, respectively.

FIG. 4B is a diagram showing an example in which power of a coarse transmit beam and power of a coarse receive beam are distributed over a spatial domain according to an embodiment of the disclosure. Referring to FIG. 4A and FIG. 4B, the TRP 40 may change the direction of the sensing transmit beam and the direction of the sensing receive beam using beam sweeping.

The power distribution 410 of the sensing transmit beam indicates transmit power of the sensing transmit beam that is radiated by the sensing transmit unit of the TRP 40 to respective regions of the coarse space (CS) using the transmit antenna. For example, CS2 transmit power 411 indicates the power of the sensing transmit beam that is radiated by the sensing transmit unit of the TRP 40 to CS2. According to an embodiment of the disclosure, the sensing transmit beam may be radiated with the same transmit power for all regions of the coarse space (CS). In addition, the sensing transmit beam may be radiated at a power relatively higher than the receive power of the sensing receive beam.

A power distribution 420 of the sensing receive beam indicates the receive power of the sensing echo signal that is received by the sensing receive unit of the TRP 40 from respective regions of the coarse space (CS) using the receive antenna. For example, CS2 receive power 421 indicates the receive power of the sensing echo signal that is received by the sensing receive unit of the TRP 40 from CS2. According to an embodiment of the disclosure, the power received by the sensing receive unit may be relatively lower than the transmit power of the sensing transmit beam. In addition, the receive power of CS2, which is the spatial region in which an object is present, may be relatively higher than the receive power of other spatial regions. Accordingly, the TRP 40 may determine that the object 41 is present in CS2, which is a spatial region having relatively high receive power.

FIG. 4C is a diagram showing an example in which power of a coarse transmit beam and power of a coarse receive beam are distributed over a time domain according to an embodiment of the disclosure. The time domain means a temporal section defined based on changes of the beam over time. Referring to FIG. 4A and FIG. 4C, the TRP 40 may change the direction of the sensing transmit beam and the direction of the sensing receive beam over time using beam sweeping.

The power distribution 430 of the sensing transmit beam indicates transmit power of the sensing transmit beam that is radiated by the sensing transmit unit of the TRP 40 using the transmit antenna at each time point. For example, the second time point transmit power 431 indicates the transmit power of the sensing transmit beam that is radiated by the sensing transmit unit of the TRP 40 at the second time point. A coarse beam burst interval 450 means a time interval from when the TRP 40 starts radiating a coarse beam for one spatial region until the TRP starts radiating a coarse beam for an adjacent spatial region. For example, when the TRP 40 radiates the sensing transmit beam to CS1 at the first time point and radiates the sensing transmit beam to CS2 at the second time point, a time interval between the first time point and the second time point may be the coarse beam burst interval 450. Equation (1) is a formula for the condition of the coarse beam burst interval 450.

$${τ}_{cb \_ burst} \geq 2 d \div c \qquad Equation ( 1 )$$

In Equation (1), τcb_burst is the coarse beam burst interval 450, d is the sensing distance, and c is the speed of light.

A coarse beam group interval 460 means a time interval from when the TRP 40 starts radiating a coarse beam for one spatial region until the TRP starts radiating a coarse beam for the same spatial region again. For example, when the TRP 40 sequentially radiates sensing transmit beams for CS1, CS2, CS3, and CS4 from the first time point to a fourth time point, respectively, and then radiates the sensing transmit beam for CS1 again at a fifth time point, a time interval between the first time point and the fifth time point may be the coarse beam group interval 460. According to an embodiment of the disclosure, the transmit power of each time domain in the time domain in which the sensing transmit beam is radiated may be same. In addition, the sensing transmit beam may be radiated at a power relatively higher than receive power of the sensing receive beam.

The power distribution 440 of the sensing receive beam indicates the receive power of the sensing echo signal that is received by the sensing receive unit of the TRP 40 using the receive antenna at each time point. For example, the second time point receive power 441 indicates the reception power of the sensing echo signal that is received by the sensing receive unit of the TRP 40 at the second time point. According to an embodiment of the disclosure, the power received by the sensing receive unit may be relatively lower than the transmit power of the sensing transmit beam. In addition, the second time point receive power 441, at which a receive beam is formed for CS2, which is the spatial region in which an object is present, may be relatively higher than the receive power at other time points. Accordingly, the TRP 40 may determine that the object 41 is present in CS2, which is the spatial region at the second time point having relatively high receive power.

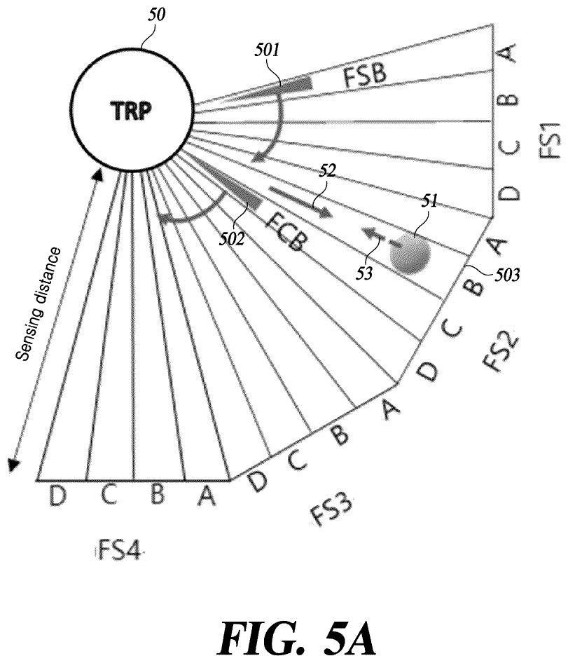

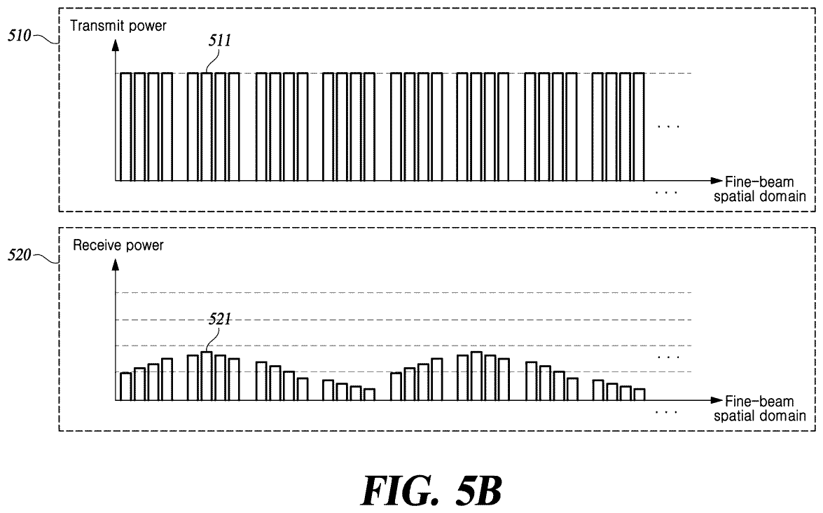

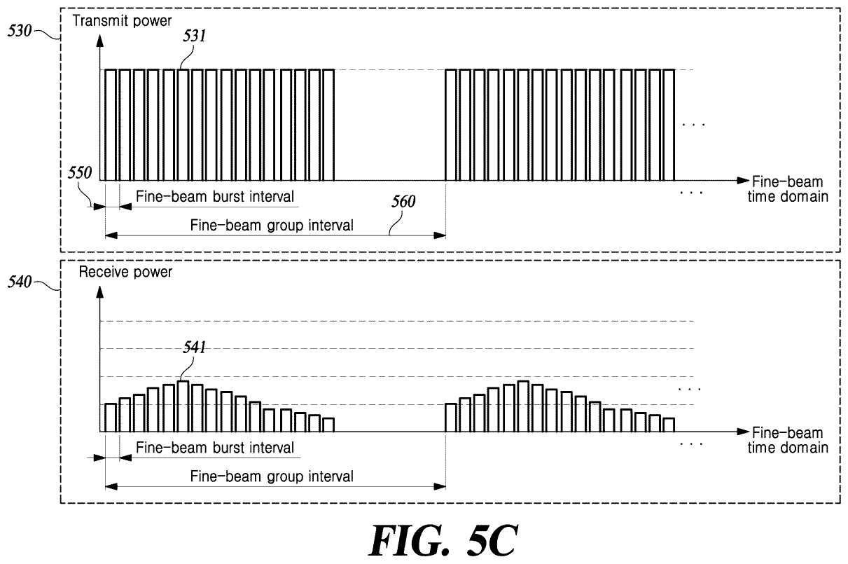

FIG. 5A is a diagram exemplarily showing integrated sensing and communication that radiates a fine beam in a monostatic sensing scheme according to an embodiment of the disclosure.

Referring to FIG. 5A, a TRP 50 radiates a fine sensing beam (FSB) 501 and a fine communication beam (FCB) 502 across a fine space (FS). The fine space (FS) means a spatial region partitioned based on the radiation direction of fine beam. The fine space (FS) according to an embodiment of the disclosure may be partitioned into FS1-A, FS1-B, FS1-C, FS1-D, FS2-A, FS2-B 503, FS2-C, FS2-D, FS3-A, FS3-B, FS3-C, FS3-D, FS4-A, FS4-B, FS4-C and FS4-D. The TRP 50 may radiate the sensing beam or the communication beam for each fine space. At the same time point, the TRP 50 radiates the sensing beam and the communication beam into different spatial regions.

Referring to FIG. 5A, the TRP 50 may radiate a fine sensing beam 501 to FS1-A and a fine communication beam 502 to FS2-C at the first time point. Thereafter, as the TRP 50 performs beam sweeping, the TRP may sequentially radiate fine beam for each fine space. For example, the TRP 50 may transmit a sensing signal 52 to FS2-B 503 using the fine sensing beam 501 at a sixth time point. An object 51 is located within a sensing distance of the TRP 50, and is present in a spatial region corresponding to FS2-B 503. The transmitted sensing signal 52 reaches the object 51 and is then reflected, and the signal reflected by the object 51 is defined as a sensing echo signal 53. The TRP 50 may determine that the object 51 is present in FS2-B 503 by receiving and signal-processing the sensing echo signal 53.

In the fine space (FS) according to an embodiment of the disclosure, different beam IDs may be pre-assigned for respective spatial regions. Since the TRP 50 radiates the fine sensing beam 501 and the fine communication beam 502 into different spatial regions at the same time point, the beam IDs of the fine sensing beam 501 and the fine communication beam 502 at the same time point are different. Meanwhile, the fine sensing beam 501 and the fine communication beam 502 radiated to the same spatial region at different time points, share the same beam ID. For example, the beam ID of the fine communication beam 502 radiated to FS2-C at the first time point and the beam ID of the fine sensing beam 501 radiated to FS2-C at a seventh time point, are same.

FIG. 5B is a diagram showing an example in which power of a fine transmit beam and power of a fine receive beam are distributed over a spatial domain according to an embodiment of the disclosure. Referring to FIG. 5A and FIG. 5B, the TRP 50 may change the direction of the sensing transmit beam and the direction of the sensing receive beam using beam sweeping.

The power distribution 510 of the sensing transmit beam indicates transmit power of the sensing transmit beam that is radiated by the sensing transmit unit of the TRP 50 to respective regions of the fine space (FS) using the transmit antenna. For example, FS2-B transmit power 511 indicates the power of the sensing transmit beam that is radiated by the sensing transmit unit of the TRP 50 to FS2-B. According to an embodiment of the disclosure, the sensing transmit beam may be radiated with the same transmit power for all regions of the fine space (FS). In addition, the sensing transmit beam may be radiated at a power relatively higher than the receive power of the sensing receive beam.

A power distribution 520 of the sensing receive beam indicates the receive power of the sensing echo signal that is received by the sensing receive unit of the TRP 50 from respective regions of the fine space (FS) using the receive antenna. For example, FS2-B receive power 521 indicates the receive power of the sensing echo signal that is received by the sensing receive unit of the TRP 50 from FS2-B. According to an embodiment of the disclosure, the power received by the sensing receive unit may be relatively lower than the transmit power of the sensing transmit beam. In addition, the receive power of FS2-B, which is the spatial region in which an object is present, may be relatively higher than the receive power of other spatial regions. Accordingly, the TRP 50 may determine that the object 51 is present in FS2-B, which is a spatial region having relatively high receive power.

FIG. 5C is a diagram showing an example in which power of a fine transmit beam and power of a fine receive beam are distributed over a time domain according to an embodiment of the disclosure. Referring to FIG. 5A and FIG. 5C, the TRP 50 may change the direction of the sensing transmit beam and the direction of the sensing receive beam over time using beam sweeping.

The power distribution 530 of the sensing transmit beam indicates transmit power of the sensing transmit beam that is radiated by the sensing transmit unit of the TRP 50 using the transmit antenna at each time point. For example, the sixth time point transmit power 531 indicates the transmit power of the sensing transmit beam that is radiated by the sensing transmit unit of the TRP 50 at the sixth time point. A fine beam burst interval 550 means a time interval from when the TRP 50 starts radiating a fine beam for one spatial region until the TRP starts radiating a fine beam for an adjacent spatial region. For example, when the TRP 50 radiates the sensing transmit beam to FS1-A at the first time point and radiates the sensing transmit beam to FS1-B at the second time point, a time interval between the first time point and the second time point may be the fine beam burst interval 550. Equation (2) is a formula for the condition of the fine beam burst interval 550.

$${τ}_{fb \_ burst} \geq 2 d \div c \qquad Equation ( 2 )$$

In Equation (2), τfb_burst is the fine beam burst interval 550, d is the sensing distance, and c is the speed of light.

A fine beam group interval 560 means a time interval from when the TRP 50 starts radiating a fine beam for one spatial region until the TRP starts radiating a fine beam for the same spatial region again. For example, when the TRP 50 sequentially radiates sensing transmit beams for FS1-A through FS4-D from the first time point to a sixteenth time point, respectively, and then radiates the sensing transmit beam for FS1-A again at a seventeenth time point, a time interval between the first time point and the seventeenth time point may be the fine beam group interval 560. According to an embodiment of the disclosure, the transmit power of each time domain in the time domain in which the sensing transmit beam is radiated may be same. In addition, the sensing transmit beam may be radiated at a power relatively higher than receive power of the sensing receive beam.

The power distribution 540 of the sensing receive beam indicates the receive power of the sensing echo signal that is received by the sensing receive unit of the TRP 50 using the receive antenna at each time point. For example, the sixth time point receive power 541 indicates the reception power of the sensing echo signal that is received by the sensing receive unit of the TRP 50 at the sixth time point. According to an embodiment of the disclosure, the power received by the sensing receive unit may be relatively lower than the transmit power of the sensing transmit beam. In addition, the sixth time point receive power 541, at which a receive beam is formed for FS2-B, which is the spatial region in which an object is present, may be relatively higher than the receive power at other time points. Accordingly, the TRP 50 may determine that the object 51 is present in FS2-B, which is the spatial region at the sixth time point having relatively high receive power.

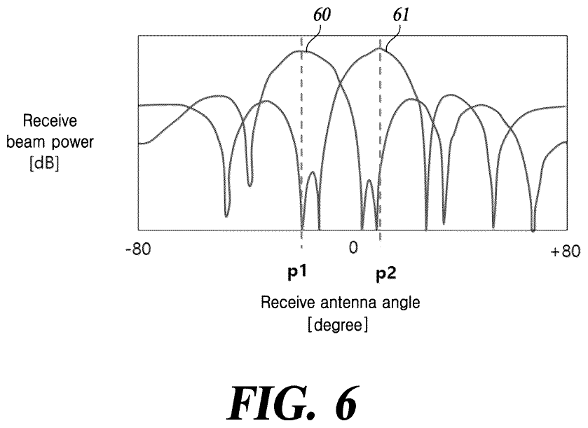

FIG. 6 is a graph showing a distribution of power of a receive beam according to an angle of a receive antenna according to an embodiment of the disclosure.

The transmitting TRP may radiate a sensing transmit beam and a communication transmit beam into different spatial regions at the same time. The transmitting TRP may commonly operate the communication function and the sensing function by configuring the single radio frequency (RF) chain, or may operate the respective functions independently by respectively configuring the communication RF chain and the sensing RF chain. The transmitting TRP may transmit the sensing signal using the sensing transmit beam. The receiving TRP may receive, by using the sensing receive beam, the sensing echo signal generated by the sensing signal transmitted by the transmitting TRP. Sensing beam receive power 60 is the power of the sensing echo signal received by the receiving TRP using the sensing receive beam. In addition, the transmitting TRP may transmit the communication signal using the communication transmit beam. The receiving TRP may receive the communication signal transmitted by the transmitting TRP using the communication receive beam. The communication beam receive power 61 is the power of the communication signal received by the receiving TRP using the communication receive beam.

Referring to FIG. 6, the horizontal axis of the graph represents an angle of the receive antenna, and the vertical axis of the graph represents the power of the receive beam. The graph shows the power of each receive beam at a first time point with respect to the angle of the receive antenna. The sensing beam receive power 60 has a maximum value when the angle of the receive antenna is p1. In contrast, the communication beam receive power 61 has a local minimum value when the angle of the receive antenna is p1. The communication beam receive power 61 has a maximum value when the angle of the receive antenna is p2. In contrast, the sensing beam receive power 60 has a local minimum value when the angle of the receive antenna is p2. By operating so that the receive powers of the sensing beam and the communication beam respectively have maxima values at different angles, the TRP may mitigate mutual interference even when the sensing function and the communication function are performed simultaneously.

Referring to FIG. 1, FIG. 2, and FIG. 6, in monostatic and bistatic sensing schemes, the receive TRP may separately extract measurements for the sensing receive beam and the communication receive beam at each measurement time point as shown in FIG. 6. In addition, as shown in FIG. 4A and FIG. 5A, by operating the sensing transmit beam and communication transmit beam separately, the receiving TRP may independently measure signals for the sensing receive beam and the communication receive beam without mutual interference, even when the communication function and sensing function are integrated.

FIG. 4A, FIG. 4B, and FIG. 4C show each example of coarse beam operation in the monostatic sensing scheme, and FIG. 5A, FIG. 5B, and FIG. 5C show each example of fine beam operation in the monostatic sensing scheme. FIG. 6 illustrates that, at each measurement time, reception of the sensing beam and reception of the communication beam may be operated separately according to the angle of the receive antenna. This concept may also be applied to the bistatic sensing scheme. The bistatic sensing scheme has a structure in which a sensing transmit system and a receive system are separated, whereas the monostatic sensing scheme has a structure in which the same system performs both transmission and reception; however, operation and processing of a sensing receive unit may be applied in the same manner in both schemes.

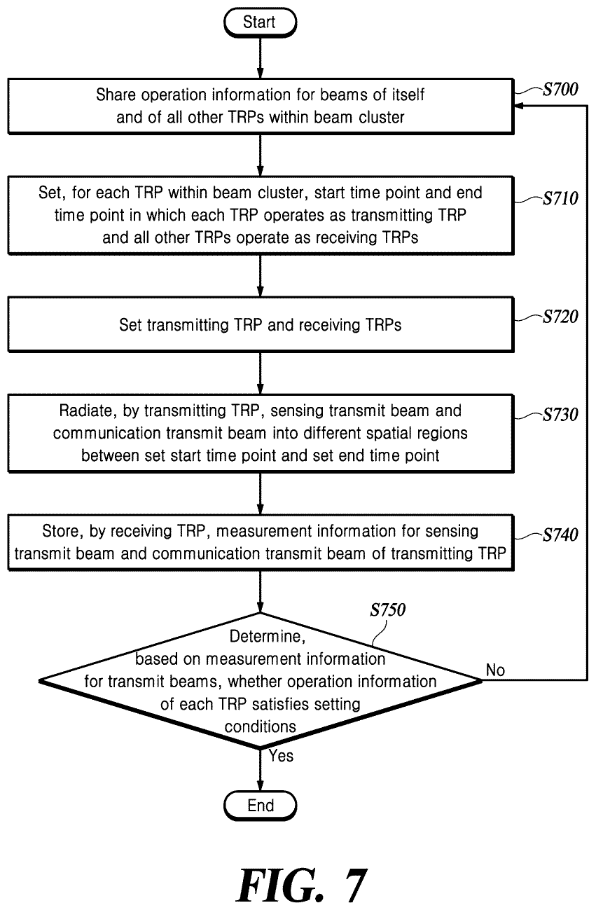

FIG. 7 is a flowchart for explaining a pre-calibration for integrated sensing and communication in a monostatic sensing scheme or bistatic sensing scheme according to an embodiment of the disclosure.

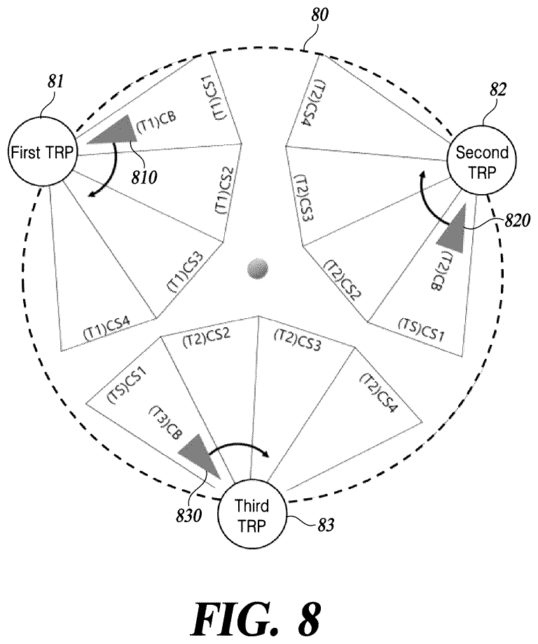

FIG. 8 is a schematic diagram showing a sensing process using coarse beams of a beam cluster formed by a plurality of TRPs according to an embodiment of the disclosure.

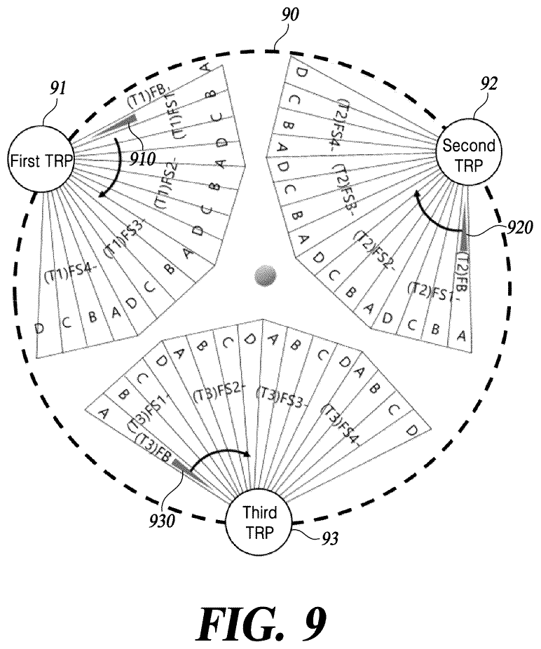

FIG. 9 is a schematic diagram showing a sensing process using fine beams of a beam cluster formed by a plurality of TRPs according to an embodiment of the disclosure.

As shown in FIG. 8 and FIG. 9, a plurality of TRPs respectively cover independent communication domains, and cell planning may be performed so as to prevent coverage holes while avoiding mutual communication interference. The cell planning may be performed by adjusting transmit power of each TRP.

In order to provide each TRP with monostatic sensing function, while each TRP operates communication beam and sensing beam, a preliminary coordination process is required so that the sensing receive beam of each TRP is not interfered with by communication transmit beams and sensing transmit beams operated by other TRPs. In the monostatic sensing scheme, the transmit power of the communication transmit beam is preferentially set from a cell-planning perspective, but the radiation regions over time of the communication transmit beam and the transmit power of the communication transmit beam may be mutually adjusted in order to mitigate interference during reception of the sensing echo signal. That is, by coordinating transmit timing, spatial distributions of beams, and transmit power among the plurality of TRPs, operation may be performed such that reception of sensing echo signals by each TRP is not interfered with by beam radiation of other TRPs.

In order to provide each TRP with bistatic sensing function, while each TRP operates communication beam and sensing beam, a preliminary coordination process is required so that the sensing receive beam of each TRP is not interfered with by communication transmit beams and sensing transmit beams operated by other TRPs. In the bistatic sensing scheme, since reception of sensing transmit beams transmitted by respective TRPs is performed by other TRPs, the transmit power of the sensing transmit beam may be set relatively higher than power of the communication transmit beam. Accordingly, operating mode of transmit beam and receive beam may be adjusted so that the sensing transmit beam does not affect the communication function and the sensing function of other TRPs.

In general, a signal-to-noise ratio (SNR) for the communication signal is set to 5 dB to 30 dB, whereas the signal-to-noise ratio for the sensing echo signal is set to a relatively low value of −20 dB. Therefore, in the process of receiving the sensing echo signal using the sensing receive beam, reception of the sensing echo signal may fail when the sensing transmit beam or the communication transmit beam of another TRP is radiated in a direction that is spatially adjacent or overlapping. Accordingly, FIG. 7 shows a procedure of adjusting an operation method so that, in operating sensing receive beams at all TRPs, communication transmit beams and sensing transmit beams of other TRPs do not cause interference in regions that are spatially adjacent or overlapping.

Referring to FIG. 7, each TRP within a beam cluster shares operation information not only for itself but also for beams of all other TRPs (S700). This may be expressed as each TRP within the beam cluster sharing operation information for beams of all TRPs within the beam cluster. The operation information for beams of all TRPs may be included in common-cell operation information for all TRPs. The common-cell operation information may include cell common parameters. The common-cell operation information may be shared with all user equipments within the beam cluster region, as well as with all TRPs within the beam cluster.

Radiation information for communication transmit beam and sensing transmit beam of the transmitting TRP for each TRP may be signaled to all TRPs within the beam cluster. The radiation information is information on spatial and temporal radiation of sensing transmit beam by the transmitting TRP. The radiation information may include a radiation start time point, a beam burst interval, a beam number, a beam group interval, a number of repeats of the beam group, and the like.

Thereafter, for each TRP within the beam cluster, a start time point and an end time point are set in which each TRP operates as a transmitting TRP and all other TRPs operate as receiving TRPs (S710). Setting the start time point and the end time point may be performed by an integrated control apparatus that manages the beam cluster, or may be performed by negotiation based on a signaling procedure between each TRP. In this case, assuming that operation information has been shared between each TRP, the negotiated information may include information whereby each TRP in the beam cluster, in accordance with the operation information, shares with all other TRPs the start time point and the end time point for the beams that it will radiate as a transmitting TRP. That is, based on the operation information, the start time point and the end time point at which each TRP within the beam cluster operates as a transmitting TRP and the remaining TRPs operate as receiving TRPs may be set, respectively, for each TRP. For example, referring to FIG. 8 and FIG. 9, information on the start time point and the end time point for the beam that a first TRP will radiate as a transmitting TRP according to the operation information, information on the start time point and the end time point for the beam that a second TRP will radiate as a transmitting TRP according to the operation information, and information on the start time point and the end time point for the beam that a third TRP will radiate as a transmitting TRP according to the operation information may be determined through a negotiation process. In addition, radiation time of the each TRP may be configured so as not to overlap with one another. The negotiation process may be performed by each of the first TRP, second TRP, and third TRP signaling, to the remaining TRPs other than itself, the start time point and the end time point according to the operation information.

After the S710 process is performed, a transmitting TRP and receiving TRPs are set based on the radiation operation information, the start time point and the end time point of the each TRP (S720). The receiving TRPs are set to all TRPs other than the transmitting TRP within the beam cluster.

Thereafter, the TRP set as the transmitting TRP radiates the sensing transmit beam and the communication transmit beam between the negotiated start time point and end time point (S730). For example, the first TRP may, based on the operation information and the negotiated start time point and end time point, radiate the sensing transmit beam to a first spatial region and radiate the communication transmit beam to a second spatial region. The transmitting TRP may transmit the sensing signal using the sensing transmit beam. For example, the first TRP may transmit the sensing signal to the first spatial region using the sensing transmit beam.

After radiating the sensing transmit beam and the communication transmit beam, the receiving TRP stores measurement information for the sensing transmit beam and the communication transmit beam of the transmitting TRP (S740). The measurement information is information on the transmit beams that is measured by the receiving TRP between the start time point and the end time point of the transmitting TRP. In the monostatic sensing scheme, since the transmitting TRP performs the function of the receiving TRP, the transmitting TRP may store the measurement information for the sensing transmit beam and the communication transmit beam as the receiving TRP. In the bistatic sensing scheme, since all TRPs other than the transmitting TRP perform the function of the receiving TRP, the remaining TRPs may store the measurement information for the sensing transmit beam and the communication transmit beam. Thereafter, if all TRPs within the beam cluster have not been set as transmitting TRP once to perform the role of transmitting TRP, a procedure of setting the transmitting TRP and the receiving TRPs may be performed again. That is, the processes S720, S730, and S740 may be expressed as being repeatedly performed by sequentially setting each TRP within the beam cluster as the transmitting TRP. This may be repeated until all TRPs within the beam cluster have each performed the role of the transmitting TRP once.

After storing transmit beam measurement information, it is determined, based on the measurement information for the transmit beams, whether operation information of the each TRP satisfies setting conditions (S750). Here, the setting conditions mean preset conditions for determining whether the operation information has been adjusted so that reception quality of the sensing echo signal is not degraded by spatiotemporal operation method of the communication transmit beam and the sensing transmit beam and so that a required receiving-performance criterion (e.g., SNR) for each TRP may be secured. The process S750 may also be expressed as a process of determining, based on the transmit beam measurement information, whether the operation information of each TRP is information that satisfies the preset conditions so as to secure the required receiving-performance criterion for each TRP.

If the operation information of each TRP is determined to satisfy the setting conditions, the pre-calibration is terminated. Otherwise, the operation information of each TRP may be adjusted, and the same pre-calibration procedure may be repeatedly performed. That is, the processes S700 to S740 may be repeatedly performed one or more times based on a determination that the information does not satisfy the preset conditions.

Referring to FIG. 8, a first TRP 81, a second TRP 82, and a third TRP 83 may be grouped as a first beam cluster 80. The first beam cluster 80 may include coarse beams radiated by each of the first TRP 81, the second TRP 82, and the third TRP 83. Each TRP may radiate the coarse beams across a plurality of coarse spaces (CS). The coarse spaces of the first TRP may be partitioned into (T1)CS1, (T1)CS2, (T1)CS3, and (T1)CS4. The coarse spaces of the second TRP may be partitioned into (T2)CS1, (T2)CS2, (T2)CS3, and (T2)CS4. The coarse spaces of the third TRP may be partitioned into (T3)CS1, (T3)CS2, (T3)CS3, and (T3)CS4. Each TRP may radiate the sensing beam and the communication beam into different spatial regions at the same time point. As each TRP performs beam sweeping, it may radiate the sensing beam and the communication beam into different spatial regions at different time points.

The first TRP 81, second TRP 82, and third TRP 83 share operational information for the beams of each TRP. Any one of the first TRP 81, second TRP 82, and third TRP 83 is set as the transmitting TRP. In the embodiment, description is made on the assumption that the first TRP 81 is first set as the transmitting TRP. The first TRP 81 signals radiation information regarding a sensing transmit beam 810 of the first TRP to the second TRP 82 and the third TRP 83. The radiation information may include (T1)CS1, which is a spatial region to which the sensing transmit beam 810 of the first TRP is radiated, a radiation start time point of the sensing transmit beam 810 of the first TRP, and the like. The first TRP 81 radiates a sensing transmit beam and a communication transmit beam into different spatial regions, based on the radiation information signaled to the second TRP 82 and the third TRP 83. The second TRP 82 and the third TRP 83 receive the transmit beams radiated by the first TRP 81 using the receive beams. The second TRP 82 may adjust radiation information regarding a sensing transmit beam 820 of the second TRP, based on the received information regarding the sensing transmit beam 810 of the first TRP. For example, the second TRP 82 may adjust the radiation information so that a spatial region of the sensing transmit beam 820 of the second TRP is set to (T2)CS1 to mitigate interference with the sensing transmit beam 810 of the first TRP. In adjusting the radiation information of the sensing transmit beam 820 of the second TRP, the second TRP 82 may also take into account information regarding a communication transmit beam of the first TRP 81. The third TRP 83 may adjust the radiation information regarding the sensing transmit beam 830 of the third TRP based on the received information about the sensing transmit beam 810 of the first TRP. For example, the third TRP 83 may adjust the radiation information so that a spatial region of the sensing transmit beam 830 of the third TRP is set to (T3)CS1 to mitigate interference with the sensing transmit beam 810 of the first TRP. In adjusting the radiation information of the sensing transmit beam 830 of the third TRP, the third TRP 83 may also take into account information regarding a communication transmit beam of the first TRP 81.

Thereafter, description is made on the assumption that the second TRP 82 is set as the transmitting TRP second. The second TRP 82 signals radiation information regarding a sensing transmit beam 820 of the second TRP to the first TRP 81 and the third TRP 83. The radiation information may include (T2)CS1, which is a spatial region to which the sensing transmit beam 820 of the second TRP is radiated, a radiation start time point of the sensing transmit beam 820 of the second TRP, and the like. The second TRP 82 radiates a sensing transmit beam and a communication transmit beam into different spatial regions, based on the radiation information signaled to the first TRP 81 and the third TRP 83. The first TRP 81 and the third TRP 83 receive the transmit beams radiated by the second TRP 82 using the receive beams. The first TRP 81 may adjust radiation information regarding a sensing transmit beam 810 of the first TRP, based on the received information regarding the sensing transmit beam 820 of the second TRP. In adjusting the radiation information of the sensing transmit beam 810 of the first TRP, the first TRP 81 may also take into account information regarding a communication transmit beam of the second TRP 82. The third TRP 83 may adjust the radiation information regarding the sensing transmit beam 830 of the third TRP based on the received information about the sensing transmit beam 820 of the second TRP. For example, the third TRP 83 may adjust the radiation information so that a spatial region of the sensing transmit beam 830 of the third TRP is set to (T3)CS1 to mitigate interference with the sensing transmit beam 820 of the second TRP. In adjusting the radiation information of the sensing transmit beam 830 of the third TRP, the third TRP 83 may also take into account information regarding a communication transmit beam of the second TRP 82. Thereafter, the third TRP 83 is set as the transmitting TRP.

Referring to FIG. 9, a first TRP 91, a second TRP 92, and a third TRP 93 may be grouped as a second beam cluster 90. The second beam cluster 90 may include fine beams radiated by each of the first TRP 91, the second TRP 92, and the third TRP 93. Each TRP may radiate the fine beams across a plurality of fine spaces (FS). The fine spaces of the first TRP may be partitioned into (T1)FS1-A, (T1)FS1-B, (T1)FS1-C, (T1)FS1-D, (T1)FS2-A, (T1)FS2-B, (T1)FS2-C, (T1)FS2-D, (T1)FS3-A, (T1)FS3-B, (T1)FS3-C, (T1)FS3-D, (T1)FS4-A, (T1)FS4-B, (T1)FS4-C, and (T1)FS4-D. The fine spaces of the second TRP may be partitioned into (T2)FS1-A, (T2)FS1-B, (T2)FS1-C, (T2)FS1-D, (T2)FS2-A, (T2)FS2-B, (T2)FS2-C, (T2)FS2-D, (T2)FS3-A, (T2)FS3-B, (T2)FS3-C, (T2)FS3-D, (T2)FS4-A, (T2)FS4-B, (T2)FS4-C, and (T2)FS4-D. The fine spaces of the third TRP may be partitioned into (T3)FS1-A, (T3)FS1-B, (T3)FS1-C, (T3)FS1-D, (T3)FS2-A, (T3)FS2-B, (T3)FS2-C, (T3)FS2-D, (T3)FS3-A, (T3)FS3-B, (T3)FS3-C, (T3)FS3-D, (T3)FS4-A, (T3)FS4-B, (T3)FS4-C, and (T3)FS4-D. Each TRP may radiate the sensing beam and the communication beam into different spatial regions at the same time point. As each TRP performs beam sweeping, it may radiate the sensing beam and the communication beam into different spatial regions at different time points.

The first TRP 91, second TRP 92, and third TRP 93 share operational information for the beams of each TRP. Any one of the first TRP 91, second TRP 92, and third TRP 93 is set as the transmitting TRP. In the embodiment, description is made on the assumption that the first TRP 91 is first set as the transmitting TRP. The first TRP 91 signals radiation information regarding a sensing transmit beam 910 of the first TRP to the second TRP 92 and the third TRP 93. The radiation information may include (T1)FS1-A, which is a spatial region to which the sensing transmit beam 910 of the first TRP is radiated, a radiation start time point of the sensing transmit beam 910 of the first TRP, and the like. The first TRP 91 radiates a sensing transmit beam and a communication transmit beam into different spatial regions, based on the radiation information signaled to the second TRP 92 and the third TRP 93. The second TRP 92 and the third TRP 93 receive the transmit beams radiated by the first TRP 91 using the receive beams. The second TRP 92 may adjust radiation information regarding a sensing transmit beam 920 of the second TRP, based on the received information regarding the sensing transmit beam 910 of the first TRP. For example, the second TRP 92 may adjust the radiation information so that a spatial region of the sensing transmit beam 920 of the second TRP is set to (T2)FS1-A to mitigate interference with the sensing transmit beam 910 of the first TRP. In adjusting the radiation information of the sensing transmit beam 920 of the second TRP, the second TRP 92 may also take into account information regarding a communication transmit beam of the first TRP 91. The third TRP 93 may adjust the radiation information regarding the sensing transmit beam 930 of the third TRP based on the received information about the sensing transmit beam 910 of the first TRP. For example, the third TRP 93 may adjust the radiation information so that a spatial region of the sensing transmit beam 930 of the third TRP is set to (T3)FS1-A to mitigate interference with the sensing transmit beam 910 of the first TRP. In adjusting the radiation information of the sensing transmit beam 930 of the third TRP, the third TRP 93 may also take into account information regarding a communication transmit beam of the first TRP 91.

Thereafter, description is made on the assumption that the second TRP 92 is set as the transmitting TRP second. The second TRP 92 signals radiation information regarding a sensing transmit beam 920 of the second TRP to the first TRP 91 and the third TRP 93. The radiation information may include (T2)FS1-A, which is a spatial region to which the sensing transmit beam 920 of the second TRP is radiated, a radiation start time point of the sensing transmit beam 920 of the second TRP, and the like. The second TRP 92 radiates a sensing transmit beam and a communication transmit beam into different spatial regions, based on the radiation information signaled to the first TRP 91 and the third TRP 93. The first TRP 91 and the third TRP 93 receive the transmit beams radiated by the second TRP 92 using the receive beams. The first TRP 91 may adjust radiation information regarding a sensing transmit beam 910 of the first TRP, based on the received information regarding the sensing transmit beam 920 of the second TRP. In adjusting the radiation information of the sensing transmit beam 910 of the first TRP, the first TRP 91 may also take into account information regarding a communication transmit beam of the second TRP 92. The third TRP 93 may adjust the radiation information regarding the sensing transmit beam 930 of the third TRP based on the received information about the sensing transmit beam 920 of the second TRP. For example, the third TRP 93 may adjust the radiation information so that a spatial region of the sensing transmit beam 930 of the third TRP is set to (T3)FS1-A to mitigate interference with the sensing transmit beam 920 of the second TRP. In adjusting the radiation information of the sensing transmit beam 930 of the third TRP, the third TRP 93 may also take into account information regarding a communication transmit beam of the second TRP 92. Thereafter, the third TRP 93 is set as the transmitting TRP.

In the structure shown in FIG. 8 or FIG. 9, when adjustment of operation information according to FIG. 7 is performed so as to satisfy the setting conditions, it means that, even considering interference caused by the communication transmit beam and the sensing transmit beam, the sensing echo signal is received at or above the required receive SNR for each TRP, thereby enabling object detection, distance estimation, and the like.

Here, the setting conditions mean reference conditions for determining whether the operation information has been adjusted so that reception quality of the sensing echo signal is not degraded by spatiotemporal operation method of the communication transmit beam and the sensing transmit beam and so that a required receiving-performance criterion (e.g., SNR) for each TRP may be secured. For example, when an object is present in the first spatial region, the transmitted sensing signal may be reflected by the object. The signal reflected by the object is defined as a sensing echo signal. The sensing receive unit may receive the sensing echo signal reflected from the first spatial region and may identify that the received sensing echo signal is a signal reflected from an object present in the first spatial region. In addition, the sensing receive unit may estimate a distance to the object based on a time difference between a sensing transmit time point and a sensing echo receive time point. Additionally, by decoding the beam ID (e.g., an orthogonal code) of the sensing echo signal, accuracy of determining the spatial region in which the object is present may be improved.

For the structures shown in FIG. 8 and FIG. 9, the operating procedure according to FIG. 7 may be applied to both monostatic sensing scheme and bistatic sensing scheme. The bistatic sensing scheme may adjust the power of the sensing transmit beam more flexibly than the monostatic sensing scheme, but may have relatively higher complexity in operation and control. Additionally, a multistatic sensing scheme may be applied by combining the monostatic sensing scheme and the bistatic sensing scheme. For example, while the first TRP uses the monostatic sensing scheme, a bistatic sensing scheme from the second TRP to the third TRP may be used. Alternatively, while the first TRP uses the monostatic sensing scheme, a bistatic sensing scheme from the third TRP to the first TRP may be used, or a bistatic sensing scheme from the first TRP to the third TRP may be used simultaneously.

In the multistatic sensing scheme as well, the adjustment procedure according to FIG. 7 may be applied in the same manner. However, as beam operation relationships between TRPs become diversified, the complexity of the procedure for adjusting beam operation information may increase.

Meanwhile, in the structures shown in FIGS. 8 and 9, the following stepwise sensing strategy may be applied. First, as shown in FIG. 8, a coarse sensing beam having a relatively wide beamwidth and low spatial resolution may be used to perform a primary search for a probable region in which an object is present. Thereafter, as shown in FIG. 9, a fine sensing beam having a relatively narrow beamwidth and high spatial resolution may be used to estimate a precise region in which the object is present. Alternatively, after performing the primary search for the probable region in which an object is present, by using the coarse sensing beam as shown in FIG. 8, overall sensing load may be reduced by selectively radiating fine sensing beams only for the probable region in which an object is present.

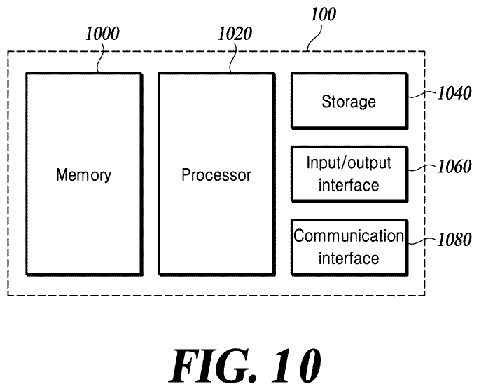

FIG. 10 is a block diagram illustrating an exemplary computing device that may be used for implementing a method or an apparatus according to the present disclosure.

The computing device 100 may include all or part of a memory 1000, a processor 1020, a storage 1040, an input/output interface 1060, and a communication interface 1080. The computing device 100 may be a stationary computing device, such as a desktop computer or a server, or a mobile computing device, such as a laptop computer or a smart phone. The computing device 100 may include a specialized hardware accelerator capable of processing operations of an artificial intelligence model in an efficient manner. For example, the computing device 100 may include a graphic processing unit (GPU), a tensor processing unit (TPU), or a neural processing unit (NPU).

The memory 1000 may store a program that enables the processor 1020 to perform methods or operations according to various embodiments of the present disclosure. For example, a program may include a plurality of instructions executable by the processor 1020, and the methods or operations described above may be performed by executing the plurality of instructions by the processor 1020. The memory 1000 may consist of a single memory or a plurality of memories. In this case, information required to perform the methods or operation according to various embodiments of the present disclosure may be stored in a single memory or distributed across a plurality of memories. When the memory 1000 is composed of a plurality of memories, the plurality of memories may be physically separated. The memory 1000 may include at least one of volatile memory and non-volatile memory. Volatile memory includes Static Random Access Memory (SRAM) or Dynamic Random Access Memory (DRAM), while non-volatile memory includes flash memory.

The processor 1020 may include at least one core capable of executing at least one instruction. The processor 1020 may execute instructions stored in the memory 1000. The processor 1020 may consist of a single processor or a plurality of processors.

The storage 1040 maintains stored data even if power supplied to the computing device 100 is cut off. For example, the storage 1040 may include non-volatile memory or may include a storage medium such as a magnetic tape, an optical disk, or a magnetic disk. A program stored in the storage 1040 may be loaded into the memory 1000 before being executed by the processor 1020. The storage 1040 may store files written in a program language, and a program created from the files by a compiler may be loaded into the memory 1000. The storage 1040 may store data to be processed by the processor 1020 and/or data processed by the processor 1020.

The input/output interface 1060 may provide an interface with an input device such as a keyboard or a mouse and/or an output device such as a display device or a printer. The user may trigger execution of a program by the processor 1020 through the input device and/or check the processing results of the processor 1020 through the output device.

The communication interface 1080 may provide access to an external network. The computing device 100 may communicate with other devices through the communication interface 1080.

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

Accordingly, one of ordinary skill would understand that the scope of the claimed invention is not to be limited by the above explicitly described embodiments but by the claims and equivalents thereof.

What is claimed:

1. A method for providing integrated sensing and communication in a wireless communication system, performed by a transmission reception point (TRP), the method comprising:
radiating, by the TRP, a sensing transmit beam and a communication transmit beam into different spatial regions,
wherein the sensing transmit beam and the communication transmit beam are assigned a same beam ID for a same spatial region.

2. The method of claim 1, wherein:
the spatial region comprises one or more of a coarse space and a fine space.

3. The method of claim 1, wherein:
the sensing transmit beam and the communication transmit beam are generated by a single RF chain or are respectively generated by different RF chains.

4. The method of claim 1, wherein:
the TRP comprises a transmit antenna and a receive antenna, and
the transmit antenna and the receive antenna are physically separated.

5. A method for providing integrated sensing and communication in a wireless communication system, performed by a beam cluster comprising one or more TRPs, the method comprising:
sharing, by each TRP within the beam cluster, operation information for all TRPs within the beam cluster;
setting, based on the operation information, a start time point and an end time point for each TRP within the beam cluster such that the each TRP operates as a transmitting TRP and all TRPs other than the each TRP operate as receiving TRPs;
setting a transmitting TRP and receiving TRPs based on the set start time point and end time point;
radiating, by the set transmitting TRP, the sensing transmit beam and the communication transmit beam into different spatial regions; and
storing, by the set receiving TRPs, measurement information for the sensing transmit beam and the communication transmit beam,
wherein the setting of the transmitting TRP and the receiving TRPs, the radiating, and the storing of the measurement information are repeatedly performed by sequentially setting each TRP within the beam cluster as the transmitting TRP, and
wherein the sensing transmit beam and the communication transmit beam are assigned a same beam ID for a same spatial region.

6. The method of claim 5, further comprising:
based on the measurement information, determining whether operation information of each TRP satisfies a preset condition to secure a required receiving-performance criterion for each TRP.

7. The method of claim 6, further comprising:
based on determining that the information does not satisfy the preset condition, repeatedly performing the method one or more times.

8. The method of claim 5, wherein:
the spatial region comprises one or more of a coarse space and a fine space.

9. The method of claim 5, wherein:
the sensing transmit beam and the communication transmit beam are generated by a single RF chain or are respectively generated by different RF chains.

10. The method of claim 5, wherein:
each TRP within the beam cluster comprises a transmit antenna and a receive antenna, and
the transmit antenna and the receive antenna are physically separated.

11. An apparatus for performing integrated sensing and communication in a wireless communication system, the apparatus being configured to operate a beam cluster comprising one or more TRPs, and the apparatus comprising:
at least one memory storing instructions; and
at least one processor configured to execute the instructions to perform operations comprising:
sharing, by each TRP within the beam cluster, operation information for all TRPs within the beam cluster;
setting, based on the operation information, a start time point and an end time point for each TRP within the beam cluster such that the each TRP operates as a transmitting TRP and all TRPs other than the each TRP operate as receiving TRPs;
setting a transmitting TRP and receiving TRPs based on the set start time point and end time point;
radiating, by the set transmitting TRP, the sensing transmit beam and the communication transmit beam into different spatial regions; and
storing, by the set receiving TRPs, measurement information for the sensing transmit beam and the communication transmit beam,
wherein the setting of the transmitting TRP and the receiving TRPs, the radiating, and the storing of the measurement information are repeatedly performed by sequentially setting each TRP within the beam cluster as the transmitting TRP, and
wherein the sensing transmit beam and the communication transmit beam are assigned a same beam ID for a same spatial region.

12. The apparatus of claim 11, wherein:
the apparatus further configured to perform, based on the measurement information, determining whether operation information of each TRP satisfies a preset condition to secure a required receiving-performance criterion for each TRP.

13. The apparatus of claim 12, wherein:
the apparatus further configured to, based on determining that the information does not satisfy the preset condition, repeatedly perform the processes of the apparatus one or more times.

14. The apparatus of claim 11, wherein:
the spatial region comprises one or more of a coarse space and a fine space.

15. The apparatus of claim 11, wherein:
the sensing transmit beam and the communication transmit beam are generated by a single RF chain or are respectively generated by different RF chains.

16. The apparatus of claim 11, wherein:
each TRP within the beam cluster comprises a transmit antenna and a receive antenna, and
the transmit antenna and the receive antenna are physically separated.
